(19) United States
(12) Patent Application Publication
(10) Pub. No.: US 2015/0060289 A1
(43) Pub. Date: Mar. 5, 2015

(54) STAMPER, METHOD OF MANUFACTURING THE SAME, AND METHOD OF MANUFACTURING MOLDED BODY

(71) Applicant: MITSUBISHI RAYON CO., LTD., Tokyo (JP)

(72) Inventors: Atsushi Saiki, Otake-shi (JP); Ayaka Kuwahara, Yokohama-shi (JP)

(21) Appl. No.: 14/367,601

(22) PCT Filed: Dec. 26, 2012
(86) PCT No.: PCT/JP2012/083635

§ 371 Date: Jun. 20, 2014

(30) Foreign Application Priority Data
Dec. 27, 2011 (JP) 2011-285652

(51) Int. Cl. C25D 11/16; B24C 1/04; B24C 11/00; G02B 1/11

(52) U.S. Cl. CPC C25D 11/16; G02B 1/11; B24C 1/04; B24C 11/00
USPC 205/50; 205/208

(57) ABSTRACT

A method of manufacturing a stamper of the invention includes: performing a blast process on an aluminum base material, and thereafter anodizing a processing surface of the blast-processed aluminum base material so that a structure which includes a rough rugged structure having an specific arithmetic average roughness Ra and a specific period Sm and a fine rugged structure which is formed on the rough rugged structure to have a shorter period than that of the rough rugged structure is formed on a surface of the aluminum base material. In the stamper of the invention, by anodizing the processing surface of the blast-processed aluminum base material, the structure which includes the specific rough rugged structure and the fine rugged structure which is formed on the specific rough rugged structure to have a shorter period than that of the rough rugged structure is formed on the surface of the aluminum base material.

### TECHNICAL FIELD

The present invention relates to a stamper, a method of manufacturing the same, and a method of manufacturing a molded body.

Priority is claimed on Japanese Patent Application No. 2011-285652, filed on Dec. 27, 2011, the content of which is incorporated herein by reference.

### BACKGROUND ART

Recently, for the purpose of applying antireflection properties, antifogging properties, antifouling properties, water repellency, and the like, a molded body such as a functional film having a fine rugged structure on the surface is suggested. Particularly, it is known that the fine rugged structure called a moth-eye structure exhibits excellent antireflection properties.

As a method of forming the fine rugged structure on the surface of the molded body, there are a method of directly processing the surface of a material, a transfer method of using a stamper (mold) having an inverted structure corresponding to the fine rugged structure and transferring the structure, and the like. In terms of productivity and economic efficiency, the latter is superior. As the method of forming the inverted structure on the stamper, electron-beam lithography, laser interference, and the like have been known. However, recently, as a method of forming the inverted structure more easily, a method of anodizing the surface of an aluminum base material has received attention.

Anodized alumina formed by anodizing the surface of the aluminum base material is a film of aluminum oxide (alumite) and has a fine rugged structure including a plurality of concave portions (pores) having a period of equal to or less than the wavelength of visible light.

In addition, a stamper having a rugged structure in which a fine rugged structure is superimposed on a rough rugged structure having a roughness to scatter light (hereinafter, referred to as a “multi-rugged structure”) on the surface is suggested.

For example, in Patent Document 1, a base material which includes a macrostructure having a structure with an average size in which the wavelength of radiation is approximately 10 to 100 times and a microstructure having a periodic sequence is disclosed.

In Patent Document 2, a stamper which includes a plurality of first convex portions having a two-dimensional size of equal to or more than 1 μm and less than 100 μm and a plurality of second convex portions which are formed thereon and therebetween and have a two-dimensional size of equal to or more than 10 nm and less than 500 nm to form an antireflection coating having a rising angle of 90° or higher with respect to the film surface of the plurality of first convex portions.

In Patent Document 3, a method of manufacturing a stamper is disclosed in which an aluminum base material of which the surface Ra has an arithmetic average roughness of equal to or less than 0.3 μm is anodized and intermetallic compounds that are present on the surface of the aluminum base material are removed to form a rough rugged structure on the surface and form a fine rugged structure on the rough rugged structure.

However, a molded body which simply has a fine rugged structure on the surface has excellent antireflection properties but also has too high transmittance. Hence, a few defects of the molded body such as cracks, scratch, or dirt of the surface of the molded body come to be noticeable in some cases. In addition, when the molded body is attached to an object, defects of the object or moire from the object, which do not cause problems in the related art, come to be noticeable in some cases.

On the other hand, a molded body having a multi-rugged structure transferred on the surface also has antiglare properties due to the rough rugged structure in addition to antireflection properties. Since the molded body having the multi-rugged structure transferred on the surface has antiglare properties, defects or moire of the molded body is not noticeable.

### CITATION LIST

### Patent Document

Patent Document 1: JP 2001-517319 W
Patent Document 2: JP 4583506 B1
Patent Document 3: JP 2010-256636 A

### DISCLOSURE OF THE INVENTION

### Problem to be Solved by the Invention

However, in the method described in Patent Document 1, the microstructure is formed by exposing a photoresist layer, which is not appropriate for manufacturing a large-size stamper. Therefore, it is difficult to manufacture a molded body with good productivity. In addition, in a case where the method of forming the macrostructure described in Patent Document 1 is applied to a high-purity aluminum base material, since high-purity aluminum is very soft, the surface thereof becomes excessively rough. As a result, the surface of the molded body on which the multi-rugged structure of the obtained stamper is transferred glitters, and defects such as color fading and whitening easily occur or degradation in image sharpness easily occurs. Therefore, there is a problem in that appearance quality is deteriorated.

In addition, in the method of manufacturing the stamper described in Patent Documents 2 and 3, the size of the rough rugged structure may be dependent on the impurities of the aluminum base material. Therefore, in a case where the impurities on the aluminum base material are not uniformly dispersed, in the molded body on which the multi-rugged structure of the stamper is transferred, detects such as unevenness, glittering, and color fading easily occur or degradation in image sharpness easily occurs. In addition, it is difficult to manufacture a molded body having excellent appearance quality with good reproducibility.

In addition, in the stamper described in Patent Document 2, after transferring the multi-rugged structure onto the surface of the molded body, it is difficult to perform demolding, and it is difficult to form the shape of the first convex portion in a shape in which the rising angle is 90° or higher.

The invention has been made taking the foregoing circumstances into consideration, and an object thereof is to provide a stamper and a method of manufacturing the same, and a method of manufacturing a molded body capable of easily manufacturing a molded body having antireflection properties, antiglare properties, and excellent appearance quality with good productivity by using the stamper.

### Means for Solving Problem

The inventors have been intensively studied. As a result, the inventors found that by performing a blast process on an aluminum base material before anodizing, a stamper capable of manufacturing a molded body having excellent appearance quality can be obtained, and completed the invention.

The invention has the following features.

<1> A method of manufacturing a stamper having a fine rugged structure formed on a surface of an aluminum base material, including: performing a blast process on the aluminum base material, and thereafter anodizing a processing surface of the blast-processed aluminum base material so that a structure which includes a rough rugged structure having an arithmetic average roughness Ra of equal to or more than 0.01 μm and less than 0.50 μm and a period Sm of 0.5 to 95 μm and the fine rugged structure which is formed on the rough rugged structure to have a shorter period than that of the rough rugged structure is formed on the surface of the aluminum base material.

<2> The method of manufacturing a stamper described in <1>, wherein the fine rugged structure is formed by a plurality of concave portions having an average depth of 80 to 500 nm and a period of 20 to 400 nm.

<3> The method of manufacturing a stamper described in <1> or <2>, wherein a Vickers hardness of the aluminum base material is 20 to 100 Hv.

<4> The method of manufacturing a stamper described in any one of <1> to <3>, wherein a shape of an abrasive used for the blast process is a spherical shape without a sharp shape.

<5> The method of manufacturing a stamper described in any one of <1> to <4>, wherein a median particle size of an abrasive used for the blast process is 35 to 150 μm.

<6> The method of manufacturing a stamper described in any one of <1> to <5>, wherein a movement speed of a discharge nozzle in the blast process is equal to or less than 30 m/min.

<7> The method of manufacturing a stamper described in any one of <1> to <6>, wherein a discharge pressure in the blast process is equal to or less than 0.2 Mpa, and a distance from a tip end of the discharge nozzle to the surface of the aluminum base material subjected to the blast process is equal to or more than 300 mm.

<8> A method of manufacturing a molded body including: transferring a surface structure of the stamper obtained in the method of manufacturing a stamper described in any one of <1> to <7> onto a surface of a body of a molded body.

<9> A stamper including: a fine rugged structure formed on a surface of an aluminum base material, wherein, by anodizing a processing surface of the blast-processed aluminum base material, a structure which includes a rough rugged structure having an arithmetic average roughness Ra of equal to or more than 0.01 μm and less than 0.50 μm and a period Sm of 0.5 to 95 μm and the fine rugged structure which is formed on the rough rugged structure to have a shorter period than that of the rough rugged structure is formed on the surface of the aluminum base material.

<10> The stamper described in <9>, wherein the fine rugged structure is formed by a plurality of concave portions having an average depth of 80 to 500 nm and a period of 20 to 400 nm.

<11> The stamper described in <9> or <10>, wherein a Vickers hardness of the aluminum base material is 20 to 100 Hv.

### Effect of the Invention

According to the method of manufacturing a stamper of the invention, the stamper which can be used to easily manufacture the molded body having antireflection properties and antiglare properties and having excellent appearance quality with good productivity is obtained.

According to the stamper of the invention, the molded body having antireflection properties and antiglare properties and having excellent appearance quality can be easily manufactured with good productivity.

According to the method of manufacturing a molded body of the invention, the molded body having antireflection properties and antiglare properties and having excellent appearance quality is obtained.

### BRIEF DESCRIPTION OF DRAWINGS

FIG. 1 is a perspective view schematically illustrating an example of a method of performing a blast process on an aluminum base material;

FIG. 2 is a cross-sectional view schematically illustrating an example of the aluminum base material after the blast process;

FIG. 3 is a cross-sectional view illustrating a manufacturing process of a stamper;

FIG. 4 is a cross-sectional view illustrating an example of a pore shape of a fine rugged structure formed on the surface of the stamper;

FIG. 5 is a cross-sectional view schematically illustrating an example of a surface structure of the stamper;

FIG. 6 is a schematic structural view illustrating an example of a manufacturing apparatus for manufacturing a molded body; and

FIG. 7 is a cross-sectional view schematically illustrating an example of the molded body.

### BEST MODES FOR CARRYING OUT THE INVENTION

Hereinafter, the invention will be described in detail with reference to the drawings.

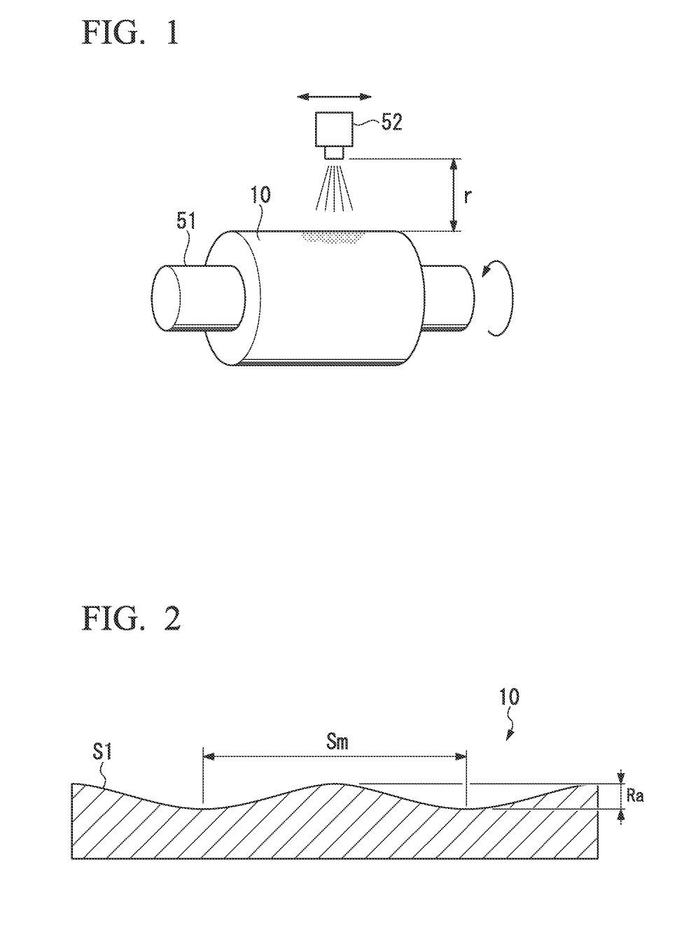

In FIGS. 1 to 7, the scales of members vary so that the members have recognizable sizes in the drawings.

In the specification, “(meth)acrylate” means acrylate or methacrylate. In addition, a “(co)polymer” means a polymer or a copolymer.

### “Method of Manufacturing Stamper”

A method of manufacturing a stamper of the invention is a method of manufacturing a stamper having on the surface a multi-rugged structure which includes a rough rugged structure formed on the surface of an aluminum base material and a fine rugged structure having a shorter period than that of the rough rugged structure.

In addition, the “period” of the rugged structure in the invention is the average of intervals (average interval) between the centers of concave portions (or convex portions) forming the rugged structure and the adjacent concave portions (or convex portions).

### <Aluminum Base Material>

As the aluminum base material, an aluminum base material which is used to manufacture the stamper having the fine rugged structure on the surface and has a surface to be processed where the fine rugged structure is to be formed.

The surface to be processed is a surface which comes into contact with the body of a molded body when the surface of the stamper is transferred onto the surface of the molded body, and a part or the entirety thereof is provided with the fine rugged structure.

The purity of the aluminum base material is preferably equal to or higher than 98 mass %, more preferably equal to or higher than 99 mass %, and even more preferably equal to or higher than 99.9 mass %. When the purity thereof is less than 98 mass %, pores may not be formed during anodizing, and even though pores are formed, the shape of the pore tends to be not vertical. The stamper manufactured from the aluminum base material having a purity of less than 98 mass % is not appropriate for manufacturing, for example, an antireflection article.

The hardness of the aluminum base material is preferably a Vickers hardness of 20 to 100 Hv, and more preferably a Vickers hardness of 25 to 95 Hv. When the Vickers hardness thereof is in the above range, external form processing such as polishing or cutting can be easily performed on the aluminum base material. In addition, the surface of the aluminum base material can be suppressed from becoming unnecessarily rough in a blast process, which will be described later.

The shape of the aluminum base material may be a flat plate or a roll shape. In consideration of productivity, the roll shape is preferable.

The surface of the aluminum base material may be mirror-finished by a method such as mechanical polishing, fabric polishing, or electropolishing before being provided to manufacture the stamper, which will be described later.

### <Manufacture of Stamper>

In the invention, after performing the blast process on the surface to be processed of the aluminum base material using the above-described aluminum base material, the processing surface is anodized to form a fine rugged structure superimposed on the rough rugged structure on the surface of the aluminum base material, thereby manufacturing the stamper. The rough rugged structure has an arithmetic average roughness Ra of equal to or more than 0.01 μm and less than 0.50 μm and a period Sm of 0.5 to 95 μm, and a fine rugged structure which is formed on the rough rugged structure has a shorter period than that of the rough rugged structure.

Hereinafter, each process will be described in detail.

### (Blast Process)

As a method of performing the blast process on the aluminum base material, well-known methods may be employed. Specifically, a method of discharging an abrasive onto the surface to be processed of the aluminum base material may be employed.

As the abrasive, a general abrasive used for the blast process may be used. For example, glass beads, sand, or iron powder may be employed. Particularly, an abrasive which has spherical shapes without sharp shapes, such as glass beads, is preferable. The reason is as follows.

In order to form pores by anodizing the aluminum base material, an aluminum base material having a high purity is preferably used. However, as the purity of the aluminum base material increases, the aluminum base material becomes softer. Therefore, when the blast process is performed before the anodizing, the aluminum base material is excessively processed and thus the processing surface is likely to become excessively rough. That is, the arithmetic average roughness Ra or the period Sm of the rough rugged structure tends to increase. As a result, the surface of the molded body on which the multi-rugged structure of the stamper is transferred glitters, and defects such as color fading and whitening occur or the haze of the molded body increases. Therefore, image sharpness is easily degraded and appearance quality is easily damaged. Therefore, the discharge pressure (blast pressure) of the abrasive needs to be adjusted so that the blast process is not excessively performed on the aluminum base material. However, when the discharge pressure is reduced, the blast process may be unevenly performed.

When the abrasive having spherical shapes without sharp shapes is used in the blast process, the aluminum base material is less likely to be excessively processed. Therefore, the rough rugged structure having an arithmetic average roughness Ra of equal to or more than 0.01 μm and less than 0.50 μm and a period Sm of 0.5 to 95 μm is easily formed. Moreover, the blast process can be performed without unnecessarily reducing the discharge pressure of the abrasive, and thus the surface of the aluminum base material can be evenly and uniformly processed.

On the other hand, when an abrasive having sharp shapes, such as alumina particles, is used, the aluminum base material is excessively processed and the processing surface is likely to become excessively rough.

Here, the “spherical shape” is not limited to a true sphere and includes a shape in which the ratio of the major axis to the minor axis (major axis/minor axis) is about 0.5 to 1 (for example, oval sphere).

In addition, “without sharp shapes” means there is no angular shapes.

The median particle size of the abrasive is preferably 35 to 150 μm, and more preferably 40 to 140 μm. When the median particle size of the abrasive is equal to or more than 35 μm, the antiglare properties of the molded body on which the surface structure of the stamper is transferred are further enhanced. In contrast, when the median particle size of the abrasive is less than 150 μm, glittering, color fading, and the like of the molded body are further suppressed. In addition, the haze of the molded body can be suppressed from rising, and thus image sharpness is further enhanced.

Here, the “median particle size” is a particle size when the integral in a volume-based particle size distribution curve is 50 volume %.

An example of the method of performing the blast process on the aluminum base material will be described with reference to FIG. 1.

First, a roll-shaped aluminum base material 10 is supported by a support member 51 so that the rotation axis (rotation center) thereof is horizontal. Subsequently, a discharge nozzle 52 which discharges the abrasive is disposed above the aluminum base material 10 so as to move parallel to the rotation axis of the aluminum base material 10. Subsequently, while the aluminum base material 10 is rotated, the discharge nozzle 52 discharges the abrasive while reciprocating parallel to the rotation axis at predetermined amplitude. The distance of the discharge nozzle 52 which moves along the rotation axis while the roll-shaped aluminum base material 10 makes one revolution is referred to as an operation pitch. Accordingly, the outer peripheral surface of the aluminum base material 10 is subjected to the blast process according to the amplitude of the discharge nozzle 52.

In a case where the aluminum substrate has a rectangular shape, the discharge nozzle 52 is moved along one side of the rectangular shape while the abrasive is discharged from the discharge nozzle 52. Next, the discharge nozzle 52 is moved by a predetermined distance (operation pitch) in a direction substantially perpendicular to the one side, and while the abrasive is discharged again, the discharge nozzle 52 is moved along the one side. By repeating this operation, the entire surface of the aluminum substrate is subjected to the blast process.

The movement speed of the discharge nozzle 52 is preferably equal to or less than 30 m/min. When the movement speed of the discharge nozzle 52 is equal to or less than 30 m/min, the aluminum base material may be uniformly subjected to the blast process. The lower limit of the movement speed of the discharge nozzle 52 is preferably equal to or higher than 5 m/min so that the surface of the aluminum base material is less likely to be processed to be excessively rough.

In addition, the movement speed of the discharge nozzle 52 is obtained by dividing the relative movement distance between the aluminum base material and the discharge nozzle by a time. In a case where the aluminum base material is a flat plate, the movement speed is obtained by dividing the total distance by which the discharge nozzle 52 moves on the flat plate by a time. In the case where the aluminum base material has a roll shape, the movement speed is obtained by dividing the total distance by which the discharge nozzle 52 moves on the outer peripheral surface of the aluminum base material in a spiral pattern by a time.

The discharge pressure at which the abrasive is discharged is preferably equal to or less than 0.2 MPa, and more preferably equal to or less than 0.15 MPa. When the discharge pressure is equal to or less than 0.2 MPa, the haze of the molded body on which the surface structure of the stamper is transferred can be suppressed from rising. The lower limit of the discharge pressure is preferably equal to or higher than 0.03 MPa so that the antiglare properties and the appearance quality of the molded body are further enhanced.

A distance r from the tip end of the discharge nozzle 52 to the surface of the aluminum base material 10 subjected to the blast process is preferably equal to or more than 300 mm. When the distance r is equal to or more than 300 mm, the haze of the molded body on which the surface structure of the stamper is transferred can be suppressed from rising. The upper limit of the distance r is preferably equal to or less than 700 mm so that the blast process can be sufficiently performed.

By performing the blast process on the aluminum base material, as illustrated in FIG. 2, a rough rugged structure S1 having an arithmetic average roughness Ra of equal to or more than 0.01 μm and less than 0.50 μm and a period Sm of 0.5 to 95 μm is formed on the blast processed (processing) surface of aluminum base material 10.

When the arithmetic average roughness Ra is equal to or more than 0.01 μm, the molded body on which the surface structure of the stamper is transferred exhibits appropriate antiglare properties, and thus defects or moire of the molded body are not noticeable. When the arithmetic average roughness Ra is less than 0.50 μm, glittering, color fading, and the like of the molded body are suppressed. In addition, the haze of the molded body can be suppressed from rising, thereby enhancing image sharpness. Therefore, the molded body having excellent appearance quality can be obtained. The arithmetic average roughness Ra is preferably equal to or more than 0.03 μm, and more preferably equal to or more than 0.10 μm so that the defects or moire of the molded body are even less noticeable. In addition, the arithmetic average roughness Ra is preferably less than 0.30 μm, and more preferably equal to or less than 0.25 μm so that the appearance quality of the molded body is further enhanced.

The arithmetic average roughness Ra is a value measured according to JIS B 0601:2001 (ISO 4287:1997).

The arithmetic average roughness Ra of the rough rugged structure S1 may be controlled by blast process conditions such as the distance r from the tip end of the discharge nozzle to the surface of the aluminum base material subjected to the blast process and the discharge pressure at which the abrasive is discharged. Specifically, when the distance r and/or the discharge pressure are increased, the arithmetic average roughness Ra tends to increase. When the distance r and/or the discharge pressure are reduced, the arithmetic average roughness Ra tends to decrease.

On the other hand, when the period Sm is equal to or more than 0.5 μm, the molded body on which the surface structure of the stamper is transferred exhibits appropriate antiglare properties, and thus defects are not noticeable. When the period Sm is equal to or less than 95 μm, appearance quality can be appropriately maintained while maintaining the antiglare properties of the molded body. The period Sm is preferably equal to or more than 1 μm, and more preferably equal to or less than 5 μm so that the defects of the molded body are even less noticeable. In addition, the period Sm is preferably equal to or less than 90 μm, and more preferably equal to or less than 70 μm so that the appearance quality of the molded body is further enhanced.

The period is a value measured according to JIS B 0601:2001 (ISO 4287:1997).

The period Sm of the rough rugged structure S1 may be controlled by a density at which the abrasive is discharged to the aluminum base material, and the discharge density of the abrasive may be controlled by the movement speed of the discharge nozzle, the amount of supplied abrasive, and the like. Specifically, when the operation pitch for blasting becomes sparse, the period Sm tends to increase. When the operation pitch for blasting becomes dense, the period Sm tends to decrease. In addition, when the particle size of the abrasive is increased, the period Sm tends to increase, and when the particle size of the abrasive is reduced, the period Sm tends to decrease.

### (Anodizing)

As a method of anodizing the processing surface of the blast-processed aluminum base material, a method of sequentially performing the following processes is preferable.

### First Oxide Film Forming Process (a):

The processing surface of the blast-processed aluminum base material is anodized in an electrolyte, and an oxide film is formed on the processing surface (hereinafter, referred to as a process (a)).

### Oxide Film Removing Process (b):

The oxide film is removed to form pore generation points for anodizing on the processing surface (hereinafter, referred to as a process (b)).

### Second Oxide Film Forming Process (c):

The processing surface of the aluminum base material where the pore generation points are formed is re-anodized in the electrolyte to form an oxide film having pores corresponding to the pore generation points on the surface to be processed (hereinafter, referred to as a process (c)).

### Pore Diameter Enlarging Process (d):

The diameters of the pores are enlarged (hereinafter, referred to as a process (d)).

### Repeating Process (e):

As needed, the second oxide film forming process (c) and the pore diameter enlarging process (d) are repeated (hereinafter, referred to as process (e)).

### Process (a):

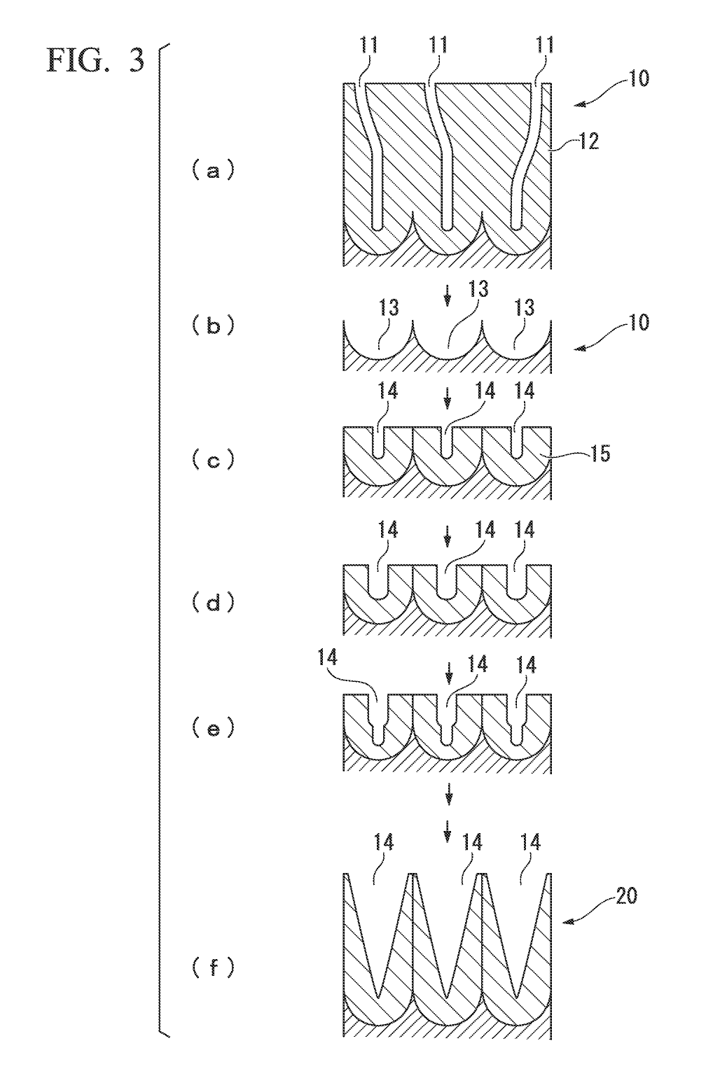

In the process (a), the processing surface of the blast-processed aluminum base material is anodized in the electrolyte at a constant voltage, and as illustrated in FIG. 3(a), an oxide film 12 having pores 11 is formed on the processing surface of the aluminum base material 10.

As the electrolyte, sulfuric acid, an aqueous solution of oxalic acid, an aqueous solution of phosphoric acid, or the like may be employed.

### Process (b):

In the process (b), the oxide film 12 formed in the process (a) is removed so that periodic dents corresponding to the bottom portion (called a barrier layer) of the removed oxide film 12, that is, pore generation points 13 are formed as illustrated in FIG. 3(b). By forming the pore generation points 13 for anodizing, the regularity of the pores that are finally formed can be enhanced.

As a method of removing the oxide film 12, a method of removing the oxide film 12 using a solution which selectively dissolves alumina without dissolving aluminum may be employed. As the solution, for example, a mixed liquid of chromic acid and phosphoric acid may be employed.

### Process (c):

In the process (c), the aluminum base material 10 on which the pore generation points 13 are formed is re-anodized in the electrolyte at a constant voltage to form an oxide film again.

Accordingly, as illustrated in FIG. 3(c), an oxide film 15 on which columnar pores 14 are formed can be formed.

As the electrolyte, the same electrolyte as that in the process (a) may be employed.

### Process (d):

In the process (d), the pore diameter enlarging process for enlarging the diameters of the pores 14 formed in the process (c) is performed to enlarge the diameters of the pores 14 as illustrated in FIG. 3(d) to be more than those of the case of FIG. 3(c).

As a specific method of the pore diameter enlarging process, a method of immersing the pores 14 in a solution that dissolves alumina to enlarge the diameters of the pores formed in the process (c) through etching may be employed. As the solution, for example, an aqueous solution of about 5 mass % of phosphoric acid may be employed. As the time for the process (d) increases, the diameters of the pores increase.

### Process (e):

In the process (e), the process (c) is performed again to form the shape of the pore 14 into a columnar shape having two different diameters as illustrated in FIG. 3(e), and thereafter, the process (d) is performed again. By the repeating process (e) of repeating the processes (c) and (d) in such a manner, as illustrated in FIG. 3(f), a stamper 20 in which anodized alumina (a porous aluminum oxide film (alumite)) having the pores 14 in a shape in which the diameters thereof continuously decrease in a depth direction from the openings is formed is obtained.

Various shapes of pores can be formed by appropriately setting the conditions of the processes (c) and (d), for example, time for anodizing and time for the pore diameter enlarging process. Therefore, depending on the use or the like of the molded body to be manufactured by using the stamper, those conditions may be appropriately set. In addition, in a case where the stamper is used to manufacture an antireflection article such as an antireflection coating, the period or depth of the pores can be arbitrarily changed by appropriately setting those conditions, and thus it is possible to design an optimal change in refractive index.

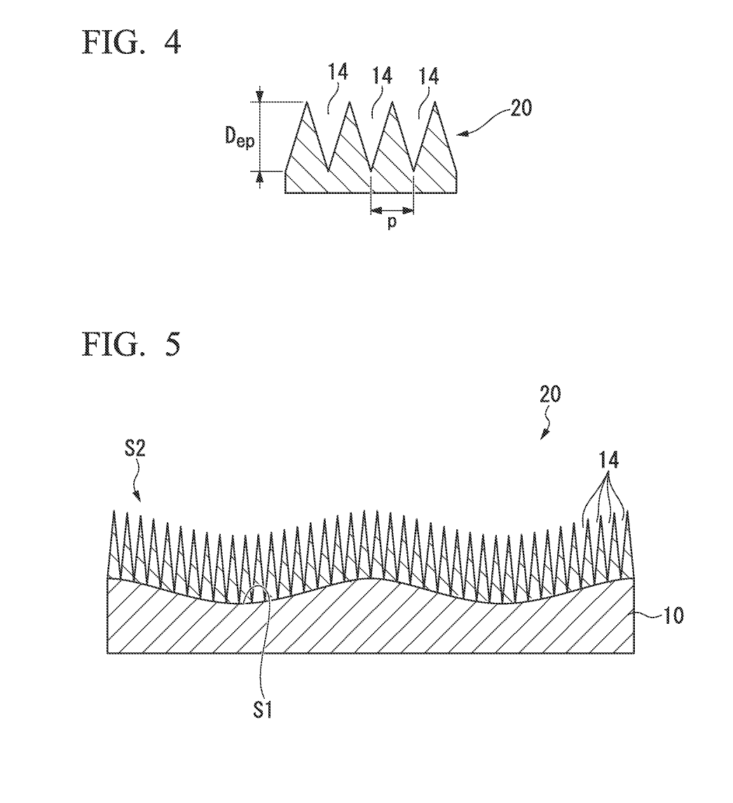

Specifically, when the processes (c) and (d) are repeated under the same conditions, conical pores 14 as illustrated in FIG. 4 are formed.

As the number of processes repeated in the process (e) is increased, pores having smoother tapered shapes may be formed. The processes (c) and (d) are preferably performed three or more times, and more preferably performed five or more times in total. When the number of processes repeated is two or less, the diameters of the pores tend to decrease discontinuously, and when an antireflection article such as an antireflection coating is manufactured from such a stamper, there is a possibility that the reflectivity reducing effect thereof may be insufficient.

As illustrated in FIG. 5, the stamper 20 manufactured as such has a surface structure which includes the rough rugged structure S1 formed on the surface of the aluminum base material 10 and a fine rugged structure S2 which is made of anodized alumina with a shorter period than that of the rough rugged structure S1 and is formed by reflecting the shape of the rough rugged structure S1. In addition, when the fine rugged structure S2 has a period of equal to or less than the wavelength of visible light, that is, equal to or less than 400 nm, the structure has a so-called moth-eye structure. Hence, the molded body on which the surface structure of the stamper is transferred can exhibit an effective antireflection function.

As illustrated in FIG. 4, the period of the fine rugged structure is the average of intervals (p in the figure) between the centers of the pores (concave portions) 14 of the fine rugged structure and the centers of the adjacent pores (concave portions) 14.

The period of the pores (concave portions) 14 is preferably equal to or less than the wavelength of visible light, that is, equal to or less than 400 nm, more preferably equal to or less than 200 nm, and even more preferably equal to or less than 150 nm. When the period is more than 400 nm, visible light is likely to scatter, and the molded body on which the surface structure of the stamper is transferred tends to be less likely to exhibit a sufficient antireflection function. The period of the pores (concave portions) 14 is preferably equal to or more than 20 nm.

In addition, the depth of the pores (concave portions) 14 is preferably 80 to 500 nm, more preferably 100 to 400 nm, and particularly preferably 130 to 300 nm. When the depth of the pores (concave portions) 14 is equal to or more than 80 nm, the reflectivity of the surface of the molded body on which the surface structure of the stamper is transferred, that is, the transferred surface thereof decreases.

As illustrated in FIG. 4, the depth of the pores (concave portions) 14 is the distance (Dₑₚ in the figure) from the opening to the deepest portion of the pore (concave portion) 14 of the fine rugged structure.

The shape of the pore (concave portion) 14 is not limited to the conical shape illustrated in FIG. 4, and may be, for example, a pyramid shape, a columnar shape, or an inverted bell shape. However, as the conical shape or the pyramid shape, a shape in which the cross-sectional area of the pore in a direction perpendicular to the depth direction continuously decreases from the outermost surface in the depth direction is preferable.

The shape of the stamper 20 may be a flat plate or a roll shape.

In addition, the surface of the stamper 20 on which the fine rugged structure S2 is formed may be processed with a mold release agent so as to be easily released from a mold. As the processing method, for example, a method of coating the surface with a silicone resin or a fluorine-containing polymer, a method of depositing a fluorine-containing compound, or a method of coating the surface with a fluorine-containing silane compound may be employed.

Although the molded body can be manufactured directly from the stamper obtained in the manufacturing method of the invention, a replica of the stamper may be manufactured first as a prototype, and the molded body may be manufactured from the replica. In addition, using the replica as the prototype, a replica may be manufactured again, and the molded body may be manufactured from the replica.

As a method of manufacturing the replica, for example, a method of forming a thin film of nickel, silver, or the like on the prototype using electroless plating, sputtering, or the like, performing electroplating (electroforming) thereon using the thin film as an electrode so as to cause nickel or the like to be deposited, and separating the nickel layer from the prototype, thereby obtaining the replica, may be employed.

In the method of manufacturing the stamper of the invention described above, after performing the blast process on the aluminum base material, the processing surface is anodized. Therefore, the stamper 20 in which a structure that includes the rough rugged structure S1 having an arithmetic average roughness Ra of equal to or more than 0.01 μm and less than 0.50 μm and a period Sm of 0.5 to 95 μm and the fine rugged structure S2 which is superimposed on the rough rugged structure S1 to have a shorter period is formed on the surface of the aluminum base material 10 is obtained. In addition, by transferring the multi-rugged structure of the surface of the stamper manufactured according to the manufacturing method of the invention onto the surface of the molded body, the haze of the molded body is likely to decrease down to, specifically, 3% to 50%. Therefore, the molded body which has excellent appearance quality (specifically, visibility is excellent while defects such as glittering and color fading are small, and image sharpness is good) and has both the antiglare function and the antireflection function is obtained.

However, in Patent Documents 2 and 3, since the rough rugged structure is formed using impurities contained in the aluminum base material, the size and the like of the rough rugged structure are easily dependent on the impurities of the aluminum base material. Therefore, it is difficult to control the structure.

In addition, as described above, in the method described in Patent Document 1, since the microstructure is formed by exposing the photoresist layer, the method is not appropriate for manufacturing a large-size stamper. Therefore, it is difficult to manufacture a molded body with good productivity. Moreover, the stamper for forming an antireflection coating having a rising angle of 90° or higher as described in Patent Document 2 or the stamper which forms the rough rugged structure by removing intermetallic compounds that are present on the surface of the aluminum base material as described in Patent Document 3 has the fine rugged structure formed on the rough rugged structure in which flat parts and pores (concave portions) having a falling angle of 90° or higher are alternately repeated. Hence, it is difficult to perform demolding after transferring the multi-rugged structure onto the surface of the molded body.

However, according to the method of manufacturing the stamper of the invention, the rough rugged structure is not formed by using the impurities contained in the aluminum base material unlike Patent Documents 2 and 3 but the rough rugged structure is formed by performing the blast process. Therefore, without depending on the purity of aluminum or the content of impurities, the structure can be easily controlled, thereby forming the rough rugged structure having a desired shape.

In addition, according to the method of manufacturing the stamper of the invention, since the fine rugged structure is formed by anodizing, a large-size stamper can be easily manufactured. Therefore, when the large-size stamper is used, the molded body can be manufactured with good productivity. Moreover, in the invention, the rough rugged structure is formed by performing the blast process before the anodizing. Therefore, as illustrated in FIG. 5, the rough rugged structure S1 of the stamper 20 has a wave pattern in which the concave portions and the convex portions are alternately repeated unlike the stampers described in Patent Documents 2 and 3. Accordingly, the stamper obtained in the invention can facilitate demolding, and thus the molded body can be easily manufactured.

[Method of Manufacturing Molded Body] A method of manufacturing the molded body of the invention is a method of transferring, on the surface of the body of the molded body, the multi-rugged structure (surface structure) which includes the rough rugged structure and the fine rugged structure formed on the surface of the stamper obtained in the method of manufacturing the stamper of the invention.

On the surface of the molded body to be manufactured by transferring the surface structure of the stamper, an inverted structure to the surface structure of the stamper is transferred in a “key and keyhole” relationship.

As the method of manufacturing the molded body, for example, the following methods may be employed.

(i) A method of filling an active energy ray-curable resin composition between the stamper and a transparent base material (the body of the molded body), irradiating the active energy ray-curable resin composition with active energy rays in a state where the active energy ray-curable resin composition comes into contact with the stamper to cure the active energy ray-curable resin composition, and thereafter separating the stamper, thereby obtaining the molded body in which the multi-rugged structure made of the cured material of the active energy ray-curable resin composition is formed on the surface of the transparent base material (that is, forming, on the surface of the transparent base material, the cured material on which the surface structure of the stamper is transferred).

(ii) A method of filling an active energy ray-curable resin composition between the stamper and a transparent base material, transferring the surface structure (the multi-rugged structure) of the stamper onto the active energy ray-curable resin composition, separating the stamper, and thereafter irradiating the active energy ray-curable resin composition with active energy rays to cure the active energy ray-curable resin composition, thereby obtaining the molded body in which the multi-rugged structure made of the cured material of the active energy ray-curable resin composition is formed on the surface of the transparent base material (that is, forming, on the surface of the transparent base material, the cured material on which the surface structure of the stamper is transferred).

Hereinafter, the method (i) will be described in detail.

The stamper and the transparent base material are caused to face each other, and the active energy ray-curable resin composition is filled therebetween to be disposed. At this time, the surface of the stamper on a side where the multi-rugged structure is formed (the front surface of the stamper) is caused to face the transparent base material. Subsequently, the filled active energy ray-curable resin composition is irradiated with the active energy rays (heat rays such as visible light, ultraviolet light, electron beams, plasma, or infrared light) via the transparent base material by, for example, a high-pressure mercury lamp or a metal halide lamp, thereby curing the active energy ray-curable resin composition. Thereafter, the stamper is separated. As a result, the molded body in which the multi-rugged structure made of the cured material of the active energy ray-curable resin composition is formed on the surface of the transparent base material is obtained. Here, as needed, active energy rays may be irradiated again after separating the stamper.

The irradiation intensity of the active energy rays may be an energy amount at which curing proceeds, and is typically 100 to 10,000 mJ/cm².

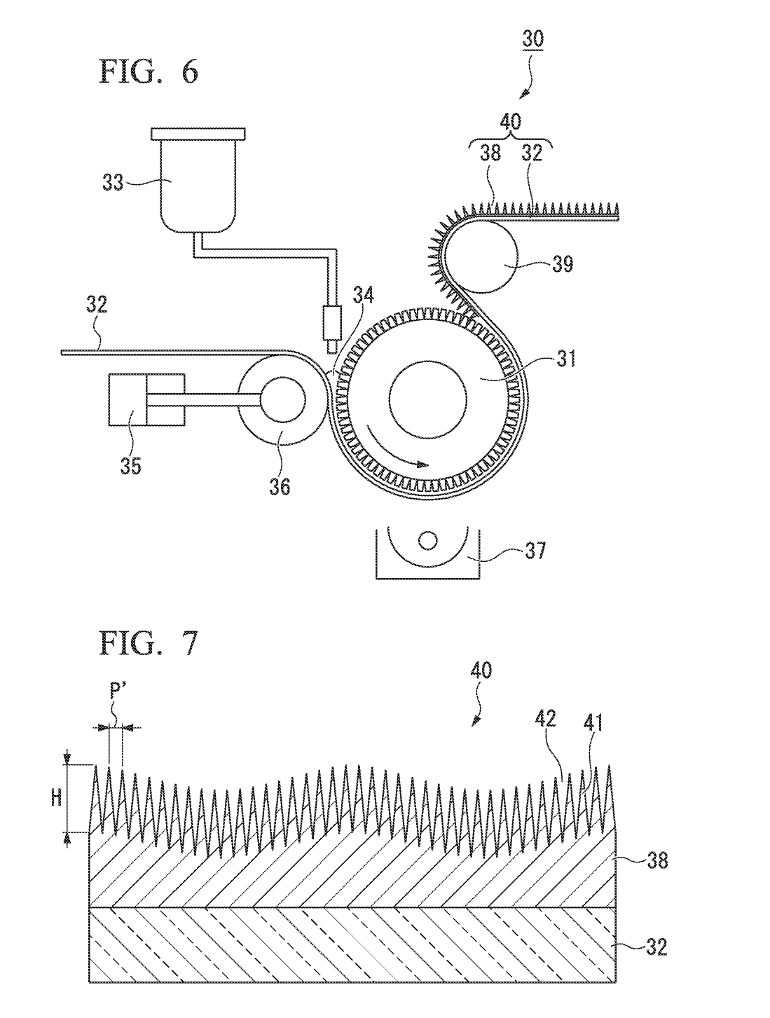

For example, when a manufacturing apparatus as illustrated in FIG. 6 is used, the molded body can be continuously manufactured. An example of the method of manufacturing the molded body using a manufacturing apparatus 30 illustrated in FIG. 6 will be described.

An active energy ray-curable resin composition 34 is supplied from a tank 33 between the surface of a roll-shaped stamper 31 having the multi-rugged structure on the surface and a band-shaped transparent base material (the body of the molded body) 32 which moves along the surface of the stamper 31.

The transparent base material 32 and the active energy ray-curable resin composition 34 are nipped between the stamper 31 and a nip roll 36 of which the nip pressure is adjusted by a pneumatic cylinder 35 to cause the active energy ray-curable resin composition 34 to uniformly spread between the transparent base material 32 and the stamper 31 and to fill the pores (concave portions) of the stamper 31.

While the stamper 31 is rotated, the active energy ray-curable resin composition 34 is irradiated with active energy rays from the transparent base material 32 side by using an active energy ray irradiating apparatus 37 provided below the stamper 31 in a state where the active energy ray-curable resin composition 34 is interposed between the stamper 31 and the transparent base material 32 to cure the active energy ray-curable resin composition 34, thereby forming, on the surface of the transparent base material 32, a cured material 38 on which the multi-rugged structure of the stamper 31 is transferred.

The transparent base material 32 having the cured material 38 formed on the surface is separated from the stamper 31 by a separation roll 39, thereby obtaining a molded body 40.

As the material of the transparent base material (the body of the molded body), a material which does not significantly impede the irradiation of the active energy rays may be used. Examples thereof include polyethylene terephthalate (PET), a methyl methacrylate (co)polymer, polycarbonate, a styrene (co)polymer, a methyl methacrylate-styrene copolymer, cellulose diacetate, cellulose triacetate, cellulose acetate butyrate, polyester, polyamide, polyimide, polyethersulfone, polysulfone, polypropylene, polymethylpentene, polyvinyl chloride, polyvinyl acetal, polyether ketone, polyurethane, a cycloolefin polymer, glass, quartz, and crystal.

The shape of the transparent base material may be appropriately selected depending on the molded body to be manufactured, and may be a sheet shape or a film shape in a case where the use of the molded body is an antireflection article such as an antireflection coating.

The surface of the transparent base material may be subjected to, for example, various coating processes or a corona discharge process in order to improve adhesion to the active energy ray-curable resin composition, antistatic properties, scratch resistance, weather resistance, and the like.

The active energy ray-curable resin composition contains a polymerizable compound and a polymerization initiator.

Examples of the polymerizable compound include a monomer having a radically polymerizable bond and/or a cationically polymerizable bond in a molecule, an oligomer, and a reactive polymer.

The active energy ray-curable resin composition may contain a non-reactive polymer and an active energy ray sol-gel reactive composition.

Examples of the monomer having a radically polymerizable bond include a monofunctional monomer and a polyfunctional monomer.

Examples of the monofunctional monomer include (meth)acrylate derivatives such as methyl (meth)acrylate, ethyl (meth)acrylate, propyl (meth)acrylate, n-butyl (meth)acrylate, i-butyl (meth)acrylate, s-butyl (meth)acrylate, t-butyl (meth)acrylate, 2-ethylhexyl (meth)acrylate, lauryl (meth)acrylate, alkyl (meth)acrylate, tridecyl (meth)acrylate, stearyl (meth)acrylate, cyclohexyl (meth)acrylate, benzyl (meth)acrylate, phenoxyethyl (meth)acrylate, isobornyl (meth)acrylate, glycidyl (meth)acrylate, tetrahydrofurfuryl (meth)acrylate, allyl (meth)acrylate, 2-hydroxyethyl (meth)acrylate, hydroxypropyl (meth)acrylate, 2-methoxyethyl (meth)acrylate, and 2-ethoxyethyl (meth)acrylate; (meth)acrylic acid, (meth)acrylonitrile; styrene derivatives such as styrene and α-methylstyrene; and (meth)acrylamide derivatives such as (meth)acrylamide, N-dimethyl (meth)acrylamide, N-diethyl (meth)acrylamide, and dimethylaminopropyl (meth)acrylamide. These may be used singly or in combination of two or more types thereof.

Examples of the polyfunctional monomer include bifunctional monomers such as ethylene glycol di(meth)acrylate, tripropylene glycol di(meth)acrylate, isocyanuric acid ethylene oxide-modified di(meth)acrylate, triethylene glycol di(meth)acrylate, diethylene glycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth)acryloxypolyethoxyphenyl)propane, 2,2-bis(4-(meth)acryloxyethoxyphenyl)propane, 2,2-bis(4-(3-(meth)acryloxy-2-hydroxypropoxy)phenyl)propane, 1,2-bis(3-(meth)acryloxy-2-hydroxypropoxy)ethane, 1,4-bis(3-(meth)acryloxy-2-hydroxypropoxy)butane, dimethylol tricyclodecane di(meth)acrylate, bisphenol A-ethylene oxide adduct dimethacrylate, bisphenol A-propylene oxide adduct dimethacrylate, hydroxypivalic acid neopentyl glycol di(meth)acrylate, divinylbenzene, and methylenebisacrylamide; trifunctional monomers such as pentaerythritol tri(meth)acrylate, trimethylolpropane tri(meth)acrylate, trimethylolpropane ethylene oxide-modified tri(meth)acrylate, trimethylolpropane propylene oxide-modified triacrylate, trimethylolpropane ethylene oxide-modified triacrylate, and isocyanuric acid ethylene oxide-modified tri(meth)acrylate; tetra- or higher functional monomers such as a condensation mixture of succinic acid/trimethylolethane/acrylic acid, dipentaerythritol hexa(meth)acrylate, dipentaerythritol penta(meth)acrylate, ditrimethylolpropane tetraacrylate, and tetramethylolmethane tetra(meth)acrylate; di- or higher functional urethane acrylate, and di- or higher functional polyester acrylate. These may be used singly or in combination of two or more types thereof.

Examples of the monomer having a cationically polymerizable bond include monomers having an epoxy group, an oxetanyl group, an oxazolyl group, a vinyloxy group, and the like, and the monomer having an epoxy group is particularly preferable.

Examples of the oligomer or the reactive polymer include unsaturated polyesters such as condensates of unsaturated dicarboxylic acids and polyols; polyester (meth)acrylate, polyether (meth)acrylate, polyol (meth)acrylate, epoxy (meth)acrylate, urethane (meth)acrylate, cationic polymerization type epoxy compounds, and homopolymers or copolymers of the above-described monomers having the radically polymerizable bond at a side chain.

Examples of the non-reactive polymer include acrylic resins, styrene-based resins, polyurethane, cellulose-based resins, polyvinyl butyral, polyester, and thermoplastic elastomers.

Examples of the active energy ray sol-gel reactive composition include alkoxysilane compounds and alkyl silicate compounds.

Examples of the alkoxysilane compounds include compounds of the following formula (1).

R¹¹ₓSi(OR¹²)_{y} (1)

where R¹¹ and R¹² respectively represent alkyl groups having 1 to 10 carbon atoms, and x and y represent integers satisfying the relationship of x+y=4.

Examples of the alkoxysilane compounds include tetramethoxysilane, tetra-i-propoxysilane, tetra-n-propoxysilane, tetra-n-butoxysilane, tetra-sec-butoxysilane, tetra-t-butoxysilane, methyltriethoxysilane, methyltripropoxysilane, methyltributoxysilane, dimethyl dimethoxysilane, dimethyldiethoxysilane, trimethylethoxysilane, trimethylmethoxysilane, trimethylpropoxysilane, and trimethylbutoxysilane.

Examples of the alkyl silicate compounds include compounds of the following formula (2).

R²¹O[Si(OR²³)(OR²⁴)O]_{z}R²² (2)

where R²¹ to R²⁴ respectively represent alkyl groups having 1 to 5 carbon atoms, and z represents an integer of 3 to 20.

Examples of the alkyl silicate compounds include methyl silicate, ethyl silicate, isopropyl silicate, n-propyl silicate, n-butyl silicate, n-pentyl silicate, and acetyl silicate.

When a photocuring reaction is used, examples of a photopolymerization initiator include carbonyl compounds such as benzoin, benzoin methyl ether, benzoin ethyl ether, benzoin isopropyl ether, benzoin isobutyl ether, benzyl, benzophenone, p-methoxybenzophenone, 2,2-diethoxyacetophenone, α,α-dimethoxy-α-phenylacetophenone, methylphenylglyoxylate, ethylphenylglyoxylate, 4,4-bis(dimethylamino)benzophenone, and 2-hydroxy-2-methyl-1-phenylpropan-1-one; sulfur compounds such as tetramethylthiuram monosulfide and tetramethylthiuram disulfide; 2,4,6-trimethylbenzoyl diphenylphosphine oxide, and benzoyl diethoxyphosphine oxide. These may be used singly or in combination of two or more types thereof.

When an electron beam curing reaction is used, examples of a polymerization initiator include thioxanthones such as benzophenone, 4,4-bis(diethylamino)benzophenone, 2,4,6-trimethylbenzophenone, methylorthobenzoyl benzoate, 4-phenylbenzophenone, t-butyl anthraquinone, 2-ethyl anthraquinone, 2,4-diethyl thioxanthone, isopropyl thioxanthone, and 2,4-dichlorothioxanthone; acetophenones such as diethoxy acetophenone, 2-hydroxy-2-methyl-1-phenylpropan-1-one, benzyl dimethyl ketal, 1-hydroxycyclohexyl-phenyl ketone, 2-methyl-2-morpholino(4-thiomethylphenyl)propan-1-one, and 2-benzyl-2-dimethylamino-1-(4-morpholinophenyl)butanone; benzoin ethers such as benzoin methyl ether, benzoin ethyl ether, benzoin isopropyl ether, and benzoin isobutyl ether; acylphosphine oxides such as 2,4,6-trimethylbenzoyl diphenylphosphine oxide, bis(2,6-dimethoxybenzoyl)-2,4,4-trimethylpentyl phosphine oxide, and bis(2,4,6-trimethylbenzoyl)-phenylphosphine oxide; methylbenzoyl formate, 1,7-bisacrydinyl heptane, and 9-phenyl acrydine. These may be used singly or in combination of two or more types thereof.

When a thermal curing reaction is used, examples of a thermopolymerization initiator include organic peroxides such as a methyl ethyl ketone peroxide, benzoyl peroxide, dicumyl peroxide, t-butyl hydroperoxide, cumene hydroperoxide, t-butyl peroxyoctoate, t-butyl peroxybenzoate, and lauroyl peroxide; azo-based compounds such as azobisisobutyronitrile; and redox polymerization initiators obtained by combining amines such as N,N-dimethylaniline or N,N-dimethyl-p-toluidine with the organic peroxides.

As needed, the active energy ray-curable resin composition may include an antistatic agent, a mold release agent, an additive such as a fluorine compound for improving antifouling properties, microparticles, and a small amount of solvent.

The molded body manufactured as described above has the transferred surface on which the surface structure of the stamper 20 as illustrated in FIG. 5 is transferred in a “key and keyhole” relationship. Specifically, as illustrated in FIG. 7, on the transferred surface of the molded body 40, the surface structure is formed which reflects both the rough rugged structure formed on the surface of the aluminum base material and the fine rugged structure made of the anodized alumina formed on the rough rugged structure.

In addition, the transferred surface may be provided on the entire surface of the molded body 40 or may be provided on a part of the surface thereof. Particularly, when the molded body 40 has a film shape, the transferred surface may be provided on the entirety of one surface or may be provided on a part of the one surface. In addition, the transferred surface may be provided on the other surface or may not be provided thereon.

The molded body 40 obtained in the invention reflects the rough rugged structure of the stamper, and preferably, has an arithmetic average roughness Ra measured according to JIS B 0601:2001 (ISO 4287:1997) in a range of equal to or more than 0.01 μm and less than 0.50 μm, thereby further exhibiting antiglare properties. In addition, the period Sm of the rough rugged structure measured according to JIS B 0601:2001 (ISO 4287:1997) is preferably 0.5 to 95 μm.

Furthermore, the molded body 40 obtained in the invention has a fine rugged structure which reflects the fine rugged structure of the stamper and thus can exhibit the antireflection function. Particularly, when the period of the fine rugged structure (the average of intervals p′ (average interval) between the centers of convex portions 41 and the adjacent convex portions 41) is equal to or less than the wavelength of visible light, that is, equal to or less than 400 nm, an effective antireflection function can be exhibited. In addition, when the height of the convex portion 41 (a vertical height H from the tip end of the convex portion 41 to the bottom portion of a concave portion 42 adjacent thereto) is 80 to 500 nm, the reflectivity is further reduced.

In the method of manufacturing the molded body of the invention described above, the surface structure (multi-rugged structure) of the stamper obtained in the method of manufacturing the stamper of the invention is transferred onto the body of the molded body. Therefore, the molded body which has antireflection properties and excellent antiglare properties and in which defects or moire are unnoticeable can be manufactured.

Moreover, since the stamper used in the method of manufacturing the molded body of the invention is manufactured by anodizing after performing the blast process, the arithmetic average roughness Ra thereof is equal to or more than 0.01 μm and less than 0.50 μm and the fine rugged structure is formed on the rough rugged structure having a period Sm of 0.5 to 95 μm. Therefore, the haze of the molded body manufactured by using the stamper is likely to decrease down to, specifically, 0.3% to 50%. Therefore, the molded body which has excellent appearance quality (specifically, visibility is excellent while defects such as glittering and color fading are small, and image sharpness is good) is obtained.

In addition, as described above, since the stamper used in the method of manufacturing the molded body of the invention has the fine rugged structure formed by anodizing, a large-size stamper can be used for manufacturing the molded body. Therefore, when the large-size stamper is used, the molded body can be manufactured with good productivity.

Moreover, since the stamper used in the method of manufacturing the molded body has the rough rugged structure formed by performing blast process before the anodizing, the rough rugged structure of the stamper has a wave pattern in which the concave portions and the convex portions are alternately repeated unlike the stampers described in Patent Documents 2 and 3. Accordingly, according to the invention, the molded body can be easily separated from the stamper (easily demolded), and the molded body can be easily manufactured.

The molded body obtained in the invention has both antireflection properties and antiglare properties, and has excellent appearance quality. Therefore, the molded body is appropriate for an antireflection coating (including an antireflection film) or an antireflection body having a three-dimensional structure.

When the molded body has a film shape, for example, the molded body is attached to the surface of an object such as image display apparatuses including liquid crystal displays, plasma display panels, electroluminescence displays, and cathode ray tube displays, lenses, store windows, lenses for eyewear, half-wave plates, and low-pass filters so as to be used.

When the molded body has a three-dimensional structure, a transparent molded body having a shape corresponding to the use is manufactured in advance, and thus may be used as a member that forms the surface of the object.

When the object is the image display apparatus, the molded body may be attached to the front surface plate of the apparatus without being limited to the surface thereof, or the front surface plate itself may be formed by the molded body.

Other uses of the molded body may include optical uses (optical waveguides, relief holograms, lenses, polarization separation elements, crystal device, and the like), cell culture sheets, super-water-repellent films, super-hydrophilic films, and the like. The super-water-repellent film may be attached to the window of a vehicle, a railcar, or the like to be used or may be used to prevent snow accretion or ice accretion of headlamps, lightings, and the like.

### EXAMPLES

Hereinafter, Examples of the invention will be described in detail, but the invention is not limited to the Examples.

### <Various Methods of Measurement and Evaluation>

### (Measurement of Arithmetic Average Roughness Ra and Period Sm)

The arithmetic average roughness Ra and the period Sm of the rough rugged structure of the stamper were obtained according to JIS B 0601:2001 (ISO 4287:1997).

In a case where the arithmetic average roughness Ra and the period Sm are measured by using a probe roughness meter (manufactured by Tokyo Seimitsu Co., Ltd., “SUPERCOM 1400 LCD”), there may be cases where it is difficult to accurately measure the surface of soft aluminum. Therefore, the arithmetic average roughness Ra and the period Sm of the rough rugged structure of the molded body on which the surface structure (multi-rugged structure) of the stamper was transferred were measured, and the measurement values were used as the arithmetic average roughness Ra and the period Sm of the rough rugged structure of the stamper.

In a case where the arithmetic average roughness Ra and the period Sm were measured by using a scanning probe microscope (manufactured by SII NanoTechnology Inc., “SPI4000 Probe Station, SPA400 (unit)”), the surface of the stamper was directly measured. As data processing, flat processing was performed after primary skew correction processing.

### (Dimensions of Pores of Stamper)

Platinum was deposited on the longitudinal cross-section or the surface of the stamper for one minute, and the surface of the stamper was observed by using an electron scanning microscope (manufactured by JEOL Ltd., “JSM-7400F”) under the conditions of an accelerating voltage of 3.00 kV. From the obtained image, the period of the pores (concave portions) and the depths of the pores of the fine rugged structure made of anodized alumina formed on the rough rugged structure were measured at 10 points, and the average value was obtained.

### (Dimensions of Convex Portions of Molded Body)

Platinum was deposited on the longitudinal cross-section or the surface of the molded body on which the transferred surface was formed for five minutes, and the transferred surface of the molded body was observed by using the electron scanning microscope (manufactured by JEOL Ltd., “JSM-7400F”) under the conditions of an accelerating voltage of 3.00 kV. From the obtained image, the period of the convex portions and the heights of the convex portions caused from the fine rugged structure of the stamper formed on the transferred surface were measured at 10 points, and the average value was obtained.

### (Measurement of Reflectivity)

The rear surface of the molded body (a surface where the surface structure of the stamper was not transferred) was painted with a black spray, and by using this as an sample, the relative reflectivity of the surface of the molded body (the transferred surface on which the surface structure of the stamper was transferred) was measured by using an spectrophotometer (manufactured by Hitachi, Ltd., “U-4100”) at an incident angle of 5° and a wavelength in a range of 380 nm to 780 nm.

### (Evaluation of Antiglare Properties)

The surface of the molded body where the fine rugged structure was formed was placed horizontally to be an upper surface. A CCFL light source was positioned at an angle of 45° with respect to the normal direction and at a height of 30 cm, and the specular-reflected CCFL image was visually observed and evaluated according to the following criteria.

⊚: The outline of the CCFL image cannot be recognized.

◯: The outline of the CCFL image can be slightly recognized.

x: The outline of the CCFL image can be clearly recognized.

### (Evaluation of Appearance Quality)

The molded body was visually inspected, and the evaluation of the appearance quality thereof was performed for the following items.

(1) Evaluation of Color Fading:

In the same manner as the evaluation of antiglare properties, the molded body was disposed and visually observed in the normal direction to be evaluated according to the following criteria.

◯: Color fading had not occurred.

Δ: Slight color fading had occurred and whitish brown was shown.

x: Color fading had occurred and whitish brown was noticeable.

(2) Evaluation of Glittering

The molded body was placed in an image display apparatus and was visually observed in a darkroom to be evaluated according to the following criteria.

◯: Glittering was invisible.

x: Glittering was visible.

(3) Evaluation of Image Sharpness

The molded body was placed in an image display apparatus and the sharpness of characters displayed on the image display apparatus was visually observed to be evaluated according to the following criteria.

◯: Characters could be clearly recognized.

Δ: Characters were slightly indistinct.

x: Characters were indistinct.

### (Measurement of Haze)

The diffuse transmittance and the total light transmittance of the molded body were measured by using a haze meter (manufactured by Murakami Color Research Laboratory Co., Ltd., “HM-150”) according to JIS K 7136:2000 (ISO 14782:1999) and haze (%) was obtained.

### Example 1

### Manufacture of Stamper

An aluminum rolled sheet (having a thickness of 0.5 mm and a Vickers hardness of 35 Hv) having a purity of 99.3 mass % was subjected to a blast process using glass beads (manufactured by Potters-Ballotini Co., Ltd., “J400”, a median particle size of 45 μm) as an abrasive having spherical shapes without sharp shapes (hereinafter, also referred to as “non-sharp spherical shapes”) under the conditions of a discharge pressure of 0.05 MPa, an operation pitch of 2.5 mm, a discharge nozzle movement speed of 20 m/min, and a distance (r) from the tip end of the discharge nozzle to the surface of an aluminum base material to be subjected to the blast process of 520 mm.

Subsequently, the aluminum base material subjected to the blast process was anodized in an aqueous solution of 0.3 M oxalic acid under the conditions of a bath temperature of 16° C. and a DC voltage of 40V for 30 minutes, thereby forming an oxide film (process (a)). The formed oxide film was temporarily dissolved and removed in a mixed aqueous solution of 6 mass % of phosphoric acid and 1.8 mass % of chromic acid (process (b)), and thereafter the result was re-anodized under the same conditions as those of the process (a) for 30 seconds, thereby forming an oxide film (process (c)). Thereafter, the result was immersed in an aqueous solution of 5 mass % of phosphoric acid (30° C.) for 8 minutes to perform the pore diameter enlarging process (process (d)) for enlarging the diameters of the pores of the oxide film. Furthermore, the processes (c) and (d) were repeated to be performed five times in total (process (e)), thereby forming anodized alumina on the aluminum base material. Subsequently, the result was immersed in a dilute solution of 0.1 mass % of OPTOOL DSX (manufactured by Daikin Industries, Ltd.) for 10 minutes and was air-dried for 24 hours, and the surface of the anodized alumina was processed by a mold release agent, thereby obtaining a stamper.

In addition, the surface of the obtained stamper was observed by a scanning probe microscope and an electron scanning microscope. The surface structure as illustrated in FIG. 5 in which a fine rugged structure including conical tapered pores (concave portions) having a period p of 100 nm and a depth Dₑₚ of 210 nm as illustrated in FIG. 4 was formed on a rough fine rugged structure having an arithmetic average roughness Ra of 0.02 μm and a period Sm of 6.0 μm was formed.

### <Preparation of Active Energy Ray-Curable Resin Composition>

45 parts by mass of a condensation reaction mixture of succinic acid/trimethylolethane/acrylic acid at a molar ratio of 1:2:4,

45 parts by mass of 1,6-hexanediol diacrylate (manufactured by Osaka Organic Chemical Industry Ltd.),

10 parts by mass of radically polymerizable silicone oil (manufactured by Shin-Etsu Chemical Co., Ltd., “X-22-1602”),

3 parts by mass of 1-hydroxycyclohexyl phenyl ketone (manufactured by Ciba Specialty Chemicals Ltd., “IRGACURE 184”), and

0.2 parts by mass of bis(2,4,6-trimethylbenzoyl)-phenyl phosphine oxide (manufactured by Ciba Specialty Chemicals Ltd., “IRGACURE 819”)

were mixed, thereby obtaining an active energy ray-curable resin composition.

### (Manufacture of Molded Body)

Several droplets of the active energy ray-curable resin composition were dropped onto the surface of the stamper, a polyethylene terephthalate film (manufactured by Toyobo Co., Ltd., “A-4300”) having a thickness of 188 μm as the body of the molded body was applied to extend thereon, and thereafter the active energy ray-curable resin composition was irradiated with ultraviolet light at an energy of 1600 mJ/cm² from the film side so as to be cured. Thereafter, the film was separated from the stamper, thereby obtaining the molded body.

The surface structure of the stamper was transferred on the surface (transferred surface) of the obtained molded body.

The surface of the obtained molded body was observed by a scanning probe microscope and an electron scanning microscope. As illustrated in FIG. 7, on the transferred surface, convex portions having a period p′ of 100 nm and a height H of 190 nm were formed. In addition, the arithmetic average roughness Ra and the period Sm of the molded body were the same as the arithmetic average roughness Ra and the period Sm of the stamper.

The reflectivity, the total light transmittance, and the haze of the obtained molded body were measured to evaluate antiglare properties and appearance quality. The results are shown in Table 2.

### Example 2

An aluminum ingot having a purity of 99.97 mass % was cut into a roll shape having a diameter of 200 mm and a width of 320 mm, and the surface thereof was cut and mirror-finished so as to be used as an aluminum base material. A stamper was manufactured in the same manner as Example 1 except that blasting conditions were changed to those in Table 1. A molded body was manufactured in the same manner as Example 1 by using the obtained stamper.

The surface of the obtained stamper was observed by an electron scanning microscope, and the dimensions of pores were measured. In addition, the surface of the obtained molded body was measured by a probe roughness meter, and the results were used as the arithmetic average roughness Ra and the period Sm of the stamper. The results are shown in Table 2.

Measurements and evaluations were performed on the obtained molded body in the same manner as Example 1. The results are shown in Table 2.

### Examples 3 and 4

Stampers were manufactured in the same manner as Example 1 except that blasting conditions were changed to those in Table 1. Molded bodies were manufactured in the same manner as Example 1 by using the obtained stampers.

The surfaces of the obtained stampers were observed by an electron scanning microscope, and the dimensions of pores were measured. In addition, the surfaces of the obtained molded bodies were measured by a probe roughness meter, and the results were used as the arithmetic average roughnesses Ra and the periods Sm of the stampers. The results are shown in Table 2. The results are shown in Table 2.

Measurements and evaluations were performed on the obtained molded bodies in the same manner as Example 1. The results are shown in Table 2.

### Comparative Example 1

A stamper was manufactured in the same manner as Example 1 except that the blast process was not performed. The surface of the obtained stamper was observed by an electron scanning microscope, and the dimensions of pores were measured. The results are shown in Table 2.

In addition, a molded body was manufactured in the same manner as Example 1 by using the obtained stamper, and measurements and evaluations were performed thereon. The results are shown in Table 2.

### Comparative Example 2

A stamper was manufactured in the same manner as Example 1 except that the blast conditions were changed to those in Table 1. The surface of the obtained stamper was observed by a scanning probe microscope and an electron scanning microscope, and the arithmetic average roughnesses Ra, the periods Sm, and the dimensions of pores were measured. The results are shown in Table 2.

In addition, a molded body was manufactured in the same manner as Example 1 by using the obtained stamper, and measurements and evaluations were performed thereon. The results are shown in Table 2.

### Comparative Example 3

A stamper was manufactured by using non-spherical alumina particles (manufactured by Showa Denko K. K., “A220”, a median particle size of 45 μm) having sharp shapes (hereinafter, as referred to as “sharp non-spherical shapes”) as an abrasive in the same manner as Example 1 except that blasting conditions were changed to those in Table 1. The surface of the obtained stamper was observed by a scanning probe microscope and an electron scanning microscope, and the arithmetic average roughnesses Ra, the periods Sm, and the dimensions of pores were measured. The results are shown in Table 2.

In addition, a molded body was manufactured in the same manner as Example 1 by using the obtained stamper, and measurements and evaluations were performed thereon. The results are shown in Table 2.

### Comparative Example 4

A stamper was manufactured in the same manner as Example 1 except that blasting conditions were changed to those in Table 1. A molded body was manufactured in the same manner as Example 1 by using the obtained stamper.

The surface of the obtained stamper was observed by an electron scanning microscope, and the dimensions of pores were measured. In addition, the surface of the obtained molded body was measured by a probe roughness meter, and the results were used as the arithmetic average roughness Ra and the period Sm of the stamper. The results are shown in Table 2.

Measurements and evaluations were performed on the obtained molded body in the same manner as Example 1. The results are shown in Table 2.

TABLE 1

| | | Blasting conditions | | | | |
|---|---|---|---|---|---|---|
| | Vickers | Abrasive | | | | |
| | hardness of | | Median | Movement | Discharge | |
| | base material | | particle size | speed | pressure | Distance r |
| | (Hv) | Shape | (μm) | (m/min) | (MPa) | (mm) |
| Example 1 | 35 | Non-sharp | 45 | 20 | 0.05 | 520 |
| | | spherical shapes | | | | |
| Example 2 | 35 | Non-sharp | 106 to 150 | 12.5 | 0.03 | 640 |
| | | spherical shapes | | | | |
| Example 3 | 35 | Non-sharp | 38 | 10 | 0.10 | 400 |
| | | spherical shapes | | | | |
| Example 4 | 35 | Non-sharp | 38 | 10 | 0.05 | 400 |
| | | spherical shapes | | | | |
| Comparative | 35 | — | — | — | — | — |
| Example 1 | | | | | | |
| Comparative | 35 | Non-sharp | 20 | 20 | 0.05 | 520 |
| Example 2 | | spherical shapes | | | | |
| Comparative | 35 | Sharp non- | 45 | 20 | 0.05 | 520 |
| Example 3 | | spherical shapes | | | | |
| Comparative | 35 | Non-sharp | 180 to 250 | 10 | 0.05 | 500 |
| Example 4 | | spherical shapes | | | | |

TABLE 2

| | Stamper | | | | | | | | | | | |
|---|---|---|---|---|---|---|---|---|---|---|---|---|
| | | | Fine rugged | | Molded body | | | | | | | |
| | | | structure | | Period | Height | | | | | | |
| | Rough rugged | | Period | Depth | of | of | Evaluation | | | | | |
| | structure | | of | of | convex | convex | | | Appearance quality | | | |
| | Ra | Sm | pores | pores | portions | portions | Reflectivity | Antiglare | Color | | Image | Haze |
| | (μm) | (μm) | (nm) | (nm) | (nm) | (nm) | (%) | properties | fading | Glittering | sharpness | (%) |
| Example 1 | 0.02 | 6.0 | 100 | 210 | 100 | 190 | 0.1 | ◯ | ◯ | ◯ | ◯ | 3.0 |
| Example 2 | 0.28 | 62.0 | 100 | 210 | 100 | 190 | 0.2 | ⊚ | ◯ | ◯ | ◯ | 18.0 |
| Example 3 | 0.04 | 29.8 | 100 | 210 | 100 | 190 | 0.2 | ⊚ | ◯ | ◯ | ◯ | 16.4 |
| Example 4 | 0.02 | 39.3 | 100 | 210 | 100 | 190 | 0.2 | ◯ | ◯ | ◯ | ◯ | 5.5 |
| Comparative | — | — | 100 | 210 | 100 | 190 | 0.1 | X | ◯ | ◯ | ◯ | 1.6 |
| Example 1 | | | | | | | | | | | | |
| Comparative | 0.003 | 15.0 | 100 | 210 | 100 | 190 | 0.1 | X | ◯ | ◯ | ◯ | 1.8 |
| Example 2 | | | | | | | | | | | | |
| Comparative | 0.6 | 22.0 | 100 | 210 | 100 | 190 | 0.1 | ◯ | Δ | X | Δ | 36.0 |
| Example 3 | | | | | | | | | | | | |
| Comparative | 1.274 | 136 | 100 | 210 | 100 | 190 | 0.3 | ⊚ | X | X | X | 78.7 |
| Example 4 | | | | | | | | | | | | |

As apparent from Table 2, the molded bodies obtained in Examples 1 to 4 had excellent antireflection properties, antiglare properties, and appearance quality.

In contrast, the molded body obtained in Comparative Example 1 in which the stamper that was manufactured without performing the blast process was used and the molded body obtained in Comparative Example 2 in which the stamper of which the rough rugged structure had an arithmetic average roughness Ra of less than 0.01 μm was used had poor antiglare properties.

In the molded body obtained in Comparative Example 3 in which the stamper that was manufactured using the non-spherical abrasive having sharp shapes, the arithmetic average roughness Ra of the rough rugged structure was equal to or more than 0.50 μm, and glittering had occurred, resulting in poor appearance quality.

The molded body obtained in Comparative Example 4 in which the stamper of which the rough rugged structure had an arithmetic average roughness Ra of 1.274 μm and a period Sm of 136 μm was used had a high haze, and color fading, glittering, and the like could be seen regarding appearance quality, resulting in poor image sharpness.

### INDUSTRIAL APPLICABILITY

According to the method of manufacturing the stamper of the invention, the stamper which can be used to easily manufacture the molded body with good productivity having antireflection properties and antiglare properties and having excellent appearance quality is obtained.

According to the stamper of the invention, the molded body having antireflection properties and antiglare properties and having excellent appearance quality can be easily manufactured with good productivity.

According to the method of manufacturing the molded body of the invention, the molded body having antireflection properties and antiglare properties and having excellent appearance quality is obtained.

### EXPLANATIONS OF LETTERS OR NUMERALS

10 aluminum base material
11, 14 pore (concave portion)
12, 15 oxide film
13 pore generation point
20, 31 stamper
32 transparent base material (body of molded body)
38 cured material
40 molded body
41 convex portion
42 concave portion
52 discharge nozzle
S1 rough rugged structure
S2 fine rugged structure

1. A method of manufacturing a stamper having a fine rugged structure formed on a surface of an aluminum base material, the method comprising:
performing a blast process on the aluminum base material, and thereafter anodizing a processing surface of the blast-processed aluminum base material so that a structure which includes a rough rugged structure having an arithmetic average roughness Ra of equal to or more than 0.01 μm and less than 0.50 μm and a period Sm of 0.5 to 95 μm and the fine rugged structure which is formed on the rough rugged structure to have a shorter period than that of the rough rugged structure is formed on the surface of the aluminum base material.

2. The method of manufacturing a stamper according to claim 1,
wherein the fine rugged structure is formed by a plurality of concave portions having an average depth of 80 to 500 nm and a period of 20 to 400 nm.

3. The method of manufacturing a stamper according to claim 1,
wherein a Vickers hardness of the aluminum base material is 20 to 100 Hv.

4. The method of manufacturing a stamper according to claim 1,
wherein a shape of an abrasive used for the blast process is a spherical shape without a sharp shape.

5. The method of manufacturing a stamper according to claim 1,
wherein a median particle size of an abrasive used for the blast process is 35 to 150 μm.

6. The method of manufacturing a stamper according to claim 1,
wherein a movement speed of a discharge nozzle in the blast process is equal to or less than 30 m/min.

7. The method of manufacturing a stamper according to claim 1,
wherein a discharge pressure in the blast process is equal to or less than 0.2 MPa, and
a distance from a tip end of the discharge nozzle to the surface of the aluminum base material subjected to the blast process is equal to or more than 300 mm.

8. A method of manufacturing a molded body comprising:
transferring a surface structure of the stamper obtained in the method of manufacturing a stamper according to claim 1 onto a surface of a body of a molded body.

9. A stamper comprising:
a fine rugged structure formed on a surface of an aluminum base material,
wherein, by anodizing a processing surface of the blast-processed aluminum base material, a structure which includes a rough rugged structure having an arithmetic average roughness Ra of equal to or more than 0.01 μm and less than 0.50 μm and a period Sm of 0.5 to 95 μm and the fine rugged structure which is formed on the rough rugged structure to have a shorter period than that of the rough rugged structure is formed on the surface of the aluminum base material.

10. The stamper according to claim 9,
wherein the fine rugged structure is formed by a plurality of concave portions having an average depth of 80 to 500 nm and a period of 20 to 400 nm.

11. The stamper according to claim 9,
wherein a Vickers hardness of the aluminum base material is 20 to 100 Hv.
